(19) United States
(12) Patent Application Publication
(10) Pub. No.: US 2025/0248412 A1
(43) Pub. Date: Aug. 7, 2025

(54) STORAGE AND DISPLAY DEVICE FOR PLANT MATTER

(71) Applicant: Leslie Graham White, Tickton, Beverley (GB)

(72) Inventor: Leslie Graham White, Tickton, Beverley (GB)

(21) Appl. No.: 18/856,178

(22) PCT Filed: Feb. 10, 2023
(86) PCT No.: PCT/EP2023/053379

§ 371 Date: Oct. 11, 2024

(30) Foreign Application Priority Data
Apr. 20, 2022 (GB) 2205733.5

(51) Int. Cl. A23B 7/158; A47G 19/30; C02F 1/32; C02F 103/32

(52) U.S. Cl. CPC A23B 7/158; A47G 19/30; C02F 1/325; C02F 2103/32; C02F 2303/04

(57) ABSTRACT

A storage and display device for plant matter comprises a body having an outer container (1) and an inner container (2) within the outer container with an enclosed space therebetween. The interior of the inner container (2) is open at the upper face thereof for receiving the plant matter in use. The enclosed space contains a water reservoir (11, 25) and at least one mist-generating device (14, 27) connected to the water reservoir. A plurality of passages (16) is provided between the enclosed space and the interior of the inner container. In an alternative arrangement, the inner container comprises a passage (40) therethrough opening at one end below the inner container and at the other end above the upper face thereof, a deflector (42) being mounted on the said other end to deflect mist passing up the passage downwardly on to the interior of the inner container.

### FIELD OF THE INVENTION

This invention relates to a storage and display device for plant matter, for example for fruit.

### BACKGROUND TO THE INVENTION

Fruit and vegetables tend to lose moisture in storage and display and misting has been used commercially to enhance freshness, for example in display cabinets in supermarkets. A problem with this type of cabinet is that it is difficult to control the atmosphere around the fruit and vegetables while still allowing access by customers to select items for purchase and at the same time ensuring that there is no excessive build-up of moisture which could encourage fungal growth and decay.

In domestic situations, fruit is often stored and displayed in an open bowl, but the problems of moisture loss mean that the storage life is limited. CN20857528U discloses a device in which interchangeable bowls can be mounted on a base having a misting column that projects into the bowl and which delivers a mist for preservation or sterilisation. However, the storage is short-term, for use with washed and peeled fruit intended to be consumed fairly quickly, and there is no disclosure of prevention of excessive moisture build-up.

### SUMMARY OF THE INVENTION

The invention provides a storage and display device for plant matter, comprising a body having an outer container and an inner container within the outer container with an enclosed space therebetween, the interior of the inner container being open at the upper face thereof for receiving the plant matter in use, wherein the enclosed space contains a water reservoir and at least one mist-generating device connected to the water reservoir and wherein a plurality of passages is provided between the enclosed space and the interior of the inner container.

The invention also provides a storage and display device for plant matter, comprising a body having an outer container and an inner container within the outer container with an enclosed space therebetween, the interior of the inner container being open at the upper face thereof for receiving the plant matter in use, wherein the enclosed space contains a water reservoir and at least one mist-generating device connected to the water reservoir and wherein the inner container comprises a passage therethrough opening at one end below the inner container and at the other end above the upper face thereof, a deflector being mounted on the said other end to deflect mist passing up the passage downwardly on to the interior of the inner container.

Other features of the invention are set out in the claims.

The storage and display device of the invention combines the advantages of misting in the storage of fruit with the attractiveness and accessibility of a fruit bowl.

### BRIEF DESCRIPTION OF THE DRAWINGS

In the drawings, which are cross-sectional elevations illustrating fruit bowls according to exemplary embodiments of the invention:

FIG. 1 illustrates a first embodiment having a plurality of low-voltage transducers;

FIG. 2 illustrates a second embodiment having a single higher-voltage transducer;

FIG. 3 illustrates a variant of the second embodiment;

FIG. 4 illustrates an alternative to the embodiments of FIGS. 2 and 3; and

FIG. 5 is a sectional view of another embodiment of the invention.

### DETAILED DESCRIPTION OF THE ILLUSTRATED EMBODIMENTS

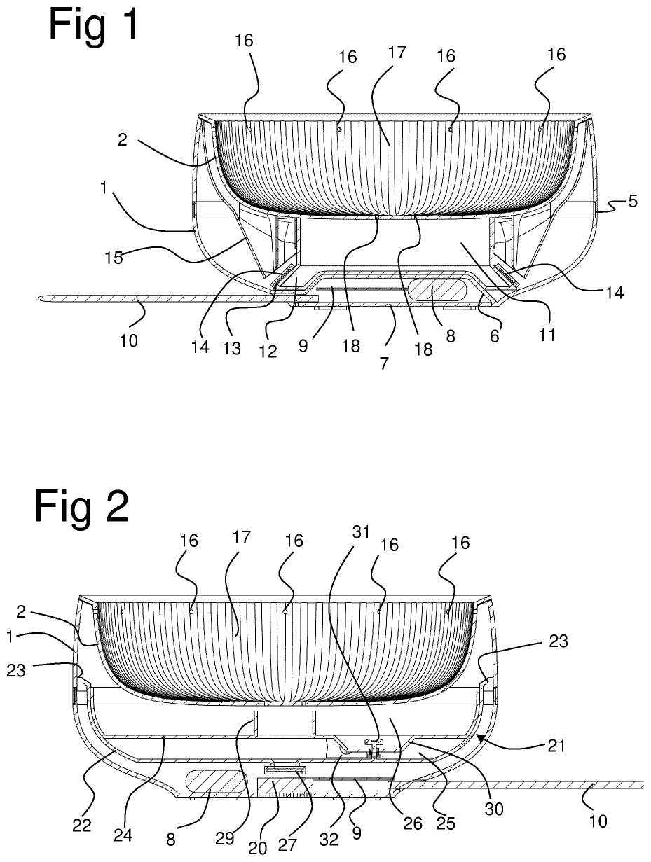

Referring to FIG. 1, the fruit storage bowl comprises a hollow moulded body, suitably formed of a plastics material, defining an outer container 1 and an inner container 2 which fits into it and is separable from it. A removable decorative trim 5 fits around the outside of the body of the outer container. This may be replaced to change the appearance of the bowl. The outer container 1 is moulded with a frusto-conical portion 6 in the lowermost surface thereof provided with a closure plate 7 which fits over the cavity formed in the underside, the cavity containing a rechargeable battery 8 and a printed circuit board (PCB) 9 mounting the control electronics. A removable charging cable 10 connected to a suitable power supply (not shown) provides a 5V charging supply to the battery when needed. A water reservoir 11 is shaped to fit over the frusto-conical portion 6 and projects upwardly from it. The lower portion 12 of the reservoir 11 presents an external face 13 which is angled at 40° to 60° to the horizontal, for example at 45° and has mounted in it two diametrically-opposed transducers 14 (it will be appreciated that there may be additional transducers, depending on the size of the bowl, equally spaced around the face 13). The transducers 14 are electrically connected to the PCB 9 and each comprises a porous membrane which on one side is exposed to the water within the reservoir and on the other side to the air. The pores in the membrane are sized such that, when the membrane is static, the water does not pass therethrough, but when the membrane is vibrated at ultrasonic frequency the water passes through the pores and forms droplets on the air side which are propelled by the vibrations into the air.

A guide member 15 surrounds the inner container 2 within the outer container 1, but is spaced therefrom to provide a flow path for the mist upwardly around the outside of the inner container 2, which is provided with a series of holes or passages 16 through to the interior, spaced around the upper part of the inner container 2, to admit the mist into the inner container. The guide member 15 extends over the transducers 14 but does not contact them.

The interior surface of the inner container 2 is provided with grooves 17 which extend from the central region of the lowermost part of the inner container 2 radially outwardly and upwardly to the upper open face thereof. The grooves 17 serve to prevent moisture build-up around the contents of the inner container, in use, by allowing the water to drain downwardly along the grooves to the lowermost part, where drainage holes 18 are provided to allow the water to drain back into the water reservoir 11.

The configuration illustrated in FIG. 2 has, in common with the embodiment illustrated in FIG. 1, the hollow moulded body formed with inner and outer containers 1 and 2 with a space between them. The outer container 1 has a flat surface at the bottom which carries a rechargeable battery 8 and a PCB 9 mounting the control electronics. Additionally, an axial fan 20 is mounted centrally of the base. A two-part removable water reservoir 21 locates in the base above the battery 8 and other electrical components. A first part 22 conforms generally with the shape of the base part 3 while leaving a gap around the outside with a series of openings 23 around the top. The second part 24 fits within the first part 22 to define a primary reservoir 25 and a removable refill reservoir 26 above it. The first part 22 has a central opening in the base thereof beneath which is mounted an ultrasonic transducer 27 which closes the opening. The second part 24 has a bottom portion, in which is moulded a central cylindrical wall 29 surrounding an opening through to the primary reservoir and a recess 30 in which a sprung float valve 31 is mounted in an aperture allowing water to flow from the refill reservoir 26 to the primary reservoir 25 when the refill reservoir is located in position within the first part 22, but which closes when the level in the primary reservoir corresponds to the lowermost part of the cylindrical wall 29. A submerged detector 32 in the primary reservoir monitors the water level therein and is linked to the PCB 9 to signal to stop operation of the device when the water level falls below a predetermined height.

In use, the ultrasonic transducer 27, which is a higher-powered device, for example operating at 24V, generating more powerful ultrasonic vibrations than the individual transducers used in the embodiment of FIG. 1, is located beneath the surface of water within the central cylindrical wall 29, causing disruption of the water surface and in turn the projection of small droplets of water therefrom in the form of a mist. The mist flows out of the top of the cylindrical wall 29 and into the space around the outside of the inner container 2, passing through the holes or passages 16 and into the interior of the inner container 2. The axial fan 20 creates an airflow between the reservoir 21 and the outer container 1, emerging through the openings 23 and assisting in driving the mist upwards and through the holes 16.

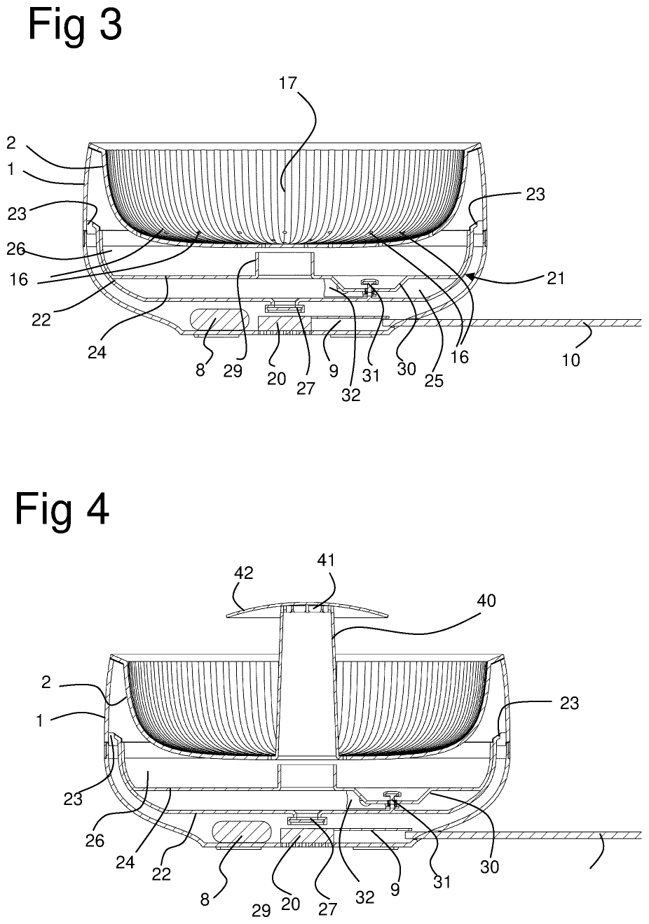

The embodiment shown in FIG. 3 differs from that of FIG. 2 only in that the holes 16 are distributed across the base of the inner container 2 instead of around the upper edge thereof, allowing the mist to rise from underneath the bowl contents.

The embodiment shown in FIG. 4 differs from that of FIG. 2 in that, instead of the holes 16 to distribute the mist, a central chimney 40 opens through the lowermost surface of the inner container 2 and extends upwards through the inner container to open at a position above the upper open face through a series of radially spaced openings 41 beneath a canopy component 42 which provides a concave surface directing the mist outwards and downwards on to the contents of the inner container, in use.

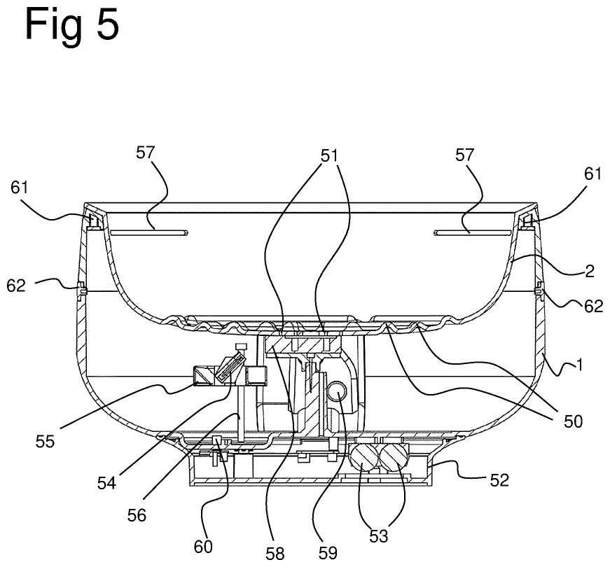

In the alternative embodiment shown in FIG. 5, the device has an outer container 1 and an inner container 2 as parts of a moulded body, the inner container 2 being provided in the base thereof with raised concentric circles 50 therein so that the contents of the inner container, in use, do not rest on the base and any moisture thereon. The inner container is provided with drainage holes 51 allowing excess moisture to flow back into the water reservoir in the outer container and beneath the inner container. The outer container 1 rests on a supporting base 52 which provides a sealed enclosure for batteries 53 and electronic components.

A low voltage ultrasonic transducer 54 is mounted on a floating carriage 55 within the reservoir space, the carriage 55 being guided on vertical pins 56 extending from the lowermost internal surface of the outer container 1. Typically, the type of transducer that uses a porous membrane is used horizontally and is fed with water by means of a wick. However, a wick would introduce a surface upon which bacteria, for example, could build up. To overcome this problem, the transducer 54 is in direct contact with the water and is angled at between 40° and 60° to the horizontal to avoid the formation of air bubbles underneath the transducer, which could prevent mist generation. Angling the transducer offers the additional advantage that the mist generated by water passing through the transducer membrane surface is directed away from the centre of the device towards the upper space between the inner and outer containers. The inner container 2 is provided with slots 57 therethrough, spaced around the upper edge thereof, to allow the mist to flow into the bowl defined by the inner container.

A IP68 rated fan 58 is mounted within the outer container in the space below the inner container and serves to generate an outward airflow that encourages the mist generated by the transducer 54 to flow outwardly and upwardly towards the slots 57. The fan 58 is positioned directly below the drainage holes 51 and also acts as a suction device to draw excess moisture from the inner container 2 back into the reservoir. A UVC LED device 59 is mounted within the reservoir and serves to sterilise the water in the reservoir to prevent the growth of algae and bacteria. The UVC LED device 59 includes a detector which monitors the radiation output, enabling a warning to be provided when the UVC radiation output has reduced to a level requiring replacement of the LED. A water sensor 60 is mounted within the reservoir to detect when the water level therein is low and to provide a signal indicating the need for replenishment.

A removable decorative trim 62 can be attached around the outer container 1, formations being provided therein to receive it. LED lights 61 are mounted around the inner container just above the slots 57 to illuminate the mist entering the bowl. The inner container 2 can be lifted out of the outer container 1 to give access to the reservoir and components such as the UVC LED unit contained therein.

While the invention has been described with reference to the storage and display of fruit, it will be appreciated that it can also be used for vegetables and, with suitable adaptation, to the display of flowers and plants.

It will be appreciated that, while low-voltage ultrasonic transducers are preferable, permitting battery operation without the need for a permanent connection to mains power supply, it would be possible to use transducers designed for operation at supply voltage (230V in the UK and Europe, 110V in the USA, for example).

What is claimed is:

1. A storage and display device for plant matter, comprising:
a body having an outer container and an inner container within the outer container with an enclosed space therebetween, an interior of the inner container being open at an upper face thereof for receiving the plant matter;
wherein the enclosed space contains a water reservoir in a space below the inner container and at least one mist-generating device within the water reservoir and
wherein a plurality of passages is provided between the enclosed space and the interior of the inner container around an upper edge of the inner container;
the inner container being provided with drainage holes configured to allow excess moisture to flow from the inner container back into the water reservoir, and
a fan being mounted within the outer container in the space below the inner container and configured to generate an outward airflow that encourages mist generated by the mist-generating device to flow outwardly and upwardly towards the passages, the fan being further configured to draw excess moisture from the inner container back into the reservoir.

2-4. (canceled)

5. The device according to claim 1, wherein the at least one mist-generating device comprises an ultrasonic transducer.

6. The device according to claim 5, wherein the ultrasonic transducer is mounted beneath the water reservoir and is configured to generate mist at a water surface beneath the inner container.

7. The device according to claim 6, wherein the ultrasonic transducer comprises a porous membrane configured to pass water therethrough only when vibrated ultrasonically, thereby generating water droplets on a surface of the porous membrane.

8. The device according to claim 7, wherein the ultrasonic transducer is mounted on a carriage that is configured to float on water in the water reservoir.

9. The device according to claim 7, wherein the transducer is mounted such that the membrane extends at an angle of between 40° and 60° from horizontal.

10. (canceled)

11. The device according to claim 1, wherein the enclosed space includes a UV light source configured to destroy bacteria in the water reservoir or in the mist.

12. The device according to claim 1, wherein the body comprises two separable parts whereby at least the inner container can be removed, thereby providing access to the water reservoir.

13. The device according to claim 12, further comprising a removable auxiliary water vessel that is connectable to the water reservoir through a valve that is configured to maintain a predetermined water level in the water reservoir.

14. The device according to claim 13, wherein the valve comprises a float.

15. The device according to claim 1, further comprising a rechargeable battery.

16. (canceled)

17. The device according to claim 1, wherein an inner surface of the inner container comprises a plurality of grooves that are configured to drain water droplets towards the at least one drainage hole.

18. The device according to claim 8, wherein the transducer is mounted such that the membrane extends at an angle of between 40° and 60° from horizontal.
